(19) United States
(12) Patent Application Publication
(10) Pub. No.: US 2024/0359339 A1
(43) Pub. Date: Oct. 31, 2024

(54) DEVICE FOR GRIPPING FOOD PRODUCTS OR PHARMACEUTICAL PRODUCTS

(71) Applicant: NTI AG, Spreitenbach (CH)

(72) Inventor: Ronald ROHNER, Remetschwil (CH)

(73) Assignee: NTI AG, Spreitenbach (CH)

(21) Appl. No.: 18/644,848

(22) Filed: Apr. 24, 2024

(30) Foreign Application Priority Data
Apr. 26, 2023 (EP) 23170124.4

(51) Int. Cl. B25J 15/02; B25J 13/08; B25J 19/00

(52) U.S. Cl. CPC B25J 15/0253; B25J 13/082; B25J 19/0075

(57) ABSTRACT

A device for gripping food products or pharmaceutical products has at least two static, straight guide rods made of stainless steel, and the guide rods are fixedly connected to one another and arranged in parallel, a first gripper carriage having a first gripper arm attached thereto, and a second gripper carriage having a second gripper arm attached thereto. The first and second gripper carriages are each arranged on the at least two guide rods, and at least the first gripper carriage is movable along the at least two guide rods. The device further has a first linear motor that contains a first stator, which is fluid-tightly enclosed by a casing made of a non-corrosive material, and a first slider arranged to be movable relative to the first stator, and the first slider has a fluid-tight slider tube made of a non-corrosive material.

The present invention relates to a device for gripping food products or pharmaceutical products according to claim 1 and to a system for gripping and transporting food products or pharmaceutical products.

Gripping devices are of fundamental importance in the automated handling of individual parts or items and are used in a large number of different industrial sectors. According to the particular requirements, which are especially determined by the weight and the dimensions of the part or item to be gripped, various types of gripping device are employed. These range from gripping devices having only a small number of fingers (for example two), in which the parts are gripped form-lockingly, to devices having a large number of movable fingers which operate both by form-locking and by force-locking engagement. There are also further types which include, in particular, vacuum grippers, magnetic grippers and adhesive grippers.

And even though there are considerable differences between the weight and the dimensions of the part or item to be gripped (such as, for example, in the case of the automatic gripping of a microprocessor as compared with a roof panel for a passenger vehicle), the gripping operations to be performed in mechanical and apparatus engineering and in industrial manufacture in that sector have in common that the parts and items to be gripped are in each case very precisely defined. This relates both to the geometric dimensions of the parts or items to be gripped and to their weight, material properties, surface characteristics, etc. The structure of industrial grippers for use in mechanical and apparatus engineering therefore usually consists of a highly developed mechanism which makes it possible to perform the gripping operation very precisely and with a high level of repetition accuracy.

The requirements for the food products industry differ very substantially from those in industrial mechanical and apparatus engineering or in industrial manufacture in that sector. In the food products industry it is fundamentally necessary to distinguish whether the gripping device is to grip an already packaged food product or the food product itself. In the former case (gripping of the already packaged food product), although the contours and dimensions of the packaging are basically also known, the tolerances of the geometric dimensions of the corresponding packaging are typically significantly greater than the tolerances of industrially manufactured parts or items in mechanical and apparatus engineering and in industrial manufacture in that sector. Moreover, packagings in the food products industry are in most cases also touch-sensitive and may not be gripped or compressed with excessive force. In the second case (gripping of the food product itself), the dimensions and also the contours of the part or item to be gripped (that is to say the food product) are known only generally and can vary considerably from the norm, for example in the case of fruit and vegetables. Even if the food products to be gripped are industrially produced products, such as, for example, bread rolls, pieces of cheese or pizzas, variations in the dimensions in the range of a few millimetres have to be expected. In the case of other products, such as, for example, pieces of meat or fish fillets, it is necessary to reckon with even larger variations from the norm in respect of the dimensions and also in respect of the contours. In addition, the properties of the different food products in terms of conventional material properties, such as, for example, density, hardness, ductility, brittleness and surface characteristics, vary within a wide range.

A very precise gripping device, as used above for industrial mechanical and apparatus engineering and in industrial manufacture in that sector, which performs a positioning movement to an accuracy of a hundredth of a millimetre using a fixed predefined force is therefore entirely unsuitable for applications in the food products sector, quite apart from the hygiene requirements of the food products industry.

For that reason, in addition to gripping devices having moving fingers, the food products industry also makes use of vacuum grippers. Since, in the food products industry, it is not always possible to achieve a complete seal between the suction head of the vacuum gripper and the product being gripped, the energy required for providing the necessary vacuum in the case of vacuum grippers in the food products industry is generally very high. A further problem in the case of vacuum grippers in the food products industry arises in respect of the hygiene required and in respect of the fact that parts of the product that is being held by suction may pass into the vacuum circuit. Particularly in the case of products of the food products industry that are still warm and therefore especially sensitive, it is often not possible to avoid undesirable marks on the product being gripped. Moreover, the gripping operation can be controlled only to a very limited extent, because the build-up or release of the vacuum is highly dependent upon the degree of sealing possible between the suction head and the product being gripped.

Magnetic gripping devices are restricted to gripping ferromagnetic parts or items; accordingly they generally cannot be used in the food products industry.

Similar requirements to those for food products also apply in whole or in part to pharmaceutical products.

Against this background, the problem underlying the invention is to provide a device for gripping food products and a system for gripping and transporting food products which make it possible to eliminate the above-mentioned disadvantages.

The device according to the invention for gripping food products or pharmaceutical products comprises
at least two static, straight guide rods made of stainless steel, which guide rods are fixedly connected to one another and arranged in parallel,
a first gripper carriage having a first gripper arm attached thereto, and
a second gripper carriage having a second gripper arm attached thereto.

The first and second gripper carriages each consist of a non-corrosive material, in particular non-corrosive plastics, and the first and second gripper arms likewise each consist of a non-corrosive material, in particular stainless steel. The first and second gripper carriages are each arranged on the at least two guide rods, at least the first gripper carriage being movable along the at least two guide rods. The device according to the invention further comprises
a first, in particular tubular, linear motor, comprising
a first stator, which is fluid-tightly enclosed by a casing made of a non-corrosive material, in particular stainless steel, and
a first slider arranged so as to be movable relative to the first stator, which first slider has a fluid-tight slider tube made of a non-corrosive material, in particular stainless steel, in which permanent magnets are arranged.

The first slider is fixedly connected to the first gripper carriage and the first stator is fixedly connected to at least one of the at least two guide rods, for movement of the first gripper carriage along the at least two guide rods by movement of the first slider relative to the first stator.

Linear motors are especially suitable for moving gripper arms for gripping food products because they are able to apply the force required for gripping food products in a controllable way and are simple to control. A linear motor suitable for use in the food products sector is described, for example, in EP 3 790 172 A1. The use of such linear motors for moving the gripper arms is advantageous because they are easy to clean. Moreover, the force generated by the linear motor is provided by the slider without any linkage elements such as belts, transmissions or spindles (that is to say virtually directly). Accordingly, the losses typical of such linkage elements do not occur at all. The force provided by the slider-disregarding very small frictional losses-therefore corresponds substantially to the force generated by the linear motor.

The use of non-corrosive materials makes it possible to use the gripping device in the food products sector and also in the field of pharmaceutical products, but for simplicity's sake reference is made only to the food products sector hereinbelow. In particular, this makes it possible for cleaning to be carried out using the cleaning products customarily used in the food products sector, which cleaning products often contain acid. Stainless steel is especially advantageous for the guide rods, because stainless steel, in addition to having the required resistance to cleaning products, also offers the stability necessary for supporting and guiding the two gripper carriages. Accordingly, stainless steel is also advantageously used for the stator and the slider of the linear motor, because stainless steel has the stability necessary for fixedly connecting the stator to at least one of the at least two guide rods and for fixedly connecting the slider to the first gripper carriage. In the case of the gripper carriages, however, a non-corrosive plastics is especially advantageous, firstly for reasons of weight (a lightweight gripper carriage enables the gripper carriage to be moved quickly with a small amount of force) and secondly for reasons of cost. A suitable non-corrosive plastics is, for example, polyoxymethylene (POM).

The arrangement of the gripper carriages on at least two guide rods allows an arrangement of the gripper carriages which, on the one hand, is stable against rotation of the gripper carriages about the longitudinal direction of the at least two guide rods and, on the other hand, is also stable against inclination of the gripper carriages in the longitudinal direction of the two guide rods. In an exemplary embodiment, the at least two guide rods are arranged one above the other, the gripping arms being oriented downwards and being arranged beneath the at least two guide rods that are arranged one above the other. As a result, during the gripping operation the forces acting on the gripper carriages due to the lever action of the gripping arms is distributed to the two guide rods which are arranged one above the other. Particularly in the case of those exemplary embodiments in which the gripper carriages are arranged on the at least two guide rods by means of a plain bearing, the plain bearings are thereby protected. Correspondingly, in the case of an alternative arrangement of the gripper carriages on the guide rods by means of an alternative bearing arrangement for the gripper carriages, for example by means of linear ball bearings or rollers, the linear ball bearings or rollers are protected.

The fixed arrangement of the gripper arms on the gripper carriages offers the advantage that the lever force acting on the two gripper arms during the gripping operation is transmitted to the guide rods, rather than, for example, acting directly on the slider of the linear motor. This prevents the force from being transmitted from the gripper arms to the slider of the linear motor, which could result in canting of the slider or the holding means connected thereto.

A static arrangement of the at least two guide rods is to be understood as being static in relation to the gripping device itself and not with respect to the product being gripped. A parallel arrangement of the at least two guide rods allows easy movement of the first gripper carriage along the guide rods (or, if the second gripper carriage is also able to move along the guide rods, also easy movement of the second gripper carriage).

The stator is fixedly connected to at least one of the at least two guide rods, but can also be fixedly connected to both (or all) of the guide rods. In this connection “fixedly connected” is intended to mean that the stator is not able to move relative to the guide rods, but is in principle adjustable in respect of its position in the longitudinal direction of the guide rods at which the stator is connected to at least one of the guide rods. That is to say, the stator can be arranged at various positions in the longitudinal direction of the guide rods and is fixedly connected to the guide rods at the particular position and is then not movable relative to the guide rods. In exemplary embodiments, the stator can be fixedly connected to the guide rods, for example, by means of a mounting block, the mounting block serving for mounting the gripping device on a transport device and, in addition, also for fixedly connecting the at least two guide rods to one another. Correspondingly, the position of the stator relative to the at least two guide rods can be adjusted in the longitudinal direction of the guide rods by adjustment of the position of the stator relative to the mounting block.

As a result, the device is also suitable for gripping products of different sizes. By adjustment of the position of the stator in the longitudinal direction of the two guide rods, the device according to the invention can be adapted to the size of the product to be gripped. The device according to the invention can therefore be used for gripping products of different sizes, such as, for example, a pizza or an olive, without it being necessary to exchange the linear motors or to use linear motors having a disproportionately large stroke.

In principle, the second gripper carriage can be fixedly arranged on the at least two guide rods, so that only the first gripper carriage is movable along the at least two guide rods. In accordance with an aspect of the device according to the invention, however, the second gripper carriage is also movable along the at least two guide rods (so that both the first and the second gripper carriage is movable along the guide rods), the device further comprising a second, in particular tubular, linear motor. The second linear motor comprises
a second stator, which is fluid-tightly enclosed by a casing made of a non-corrosive material, in particular stainless steel, and
a second slider arranged so as to be movable relative to the second stator, which second slider has a fluid-tight slider tube made of a non-corrosive material, in particular stainless steel, in which permanent magnets are arranged.

The second slider is fixedly connected to the second gripper carriage and the second stator is fixedly connected to at least one of the at least two guide rods, for movement of the second gripper carriage along the at least two guide rods by movement of the second slider relative to the second stator.

Because both the first and second gripper carriages are movable and the second gripper carriage is driven by a separate second linear motor, both the first and the second gripper arm can be controlled and moved separately and independently of one another. The movability of both gripper carriages and therefore also of both gripper arms enables products to be gripped without it being necessary to move the entire device for gripping the product, as can be the case with a fixed arrangement of the second gripper carriage on the guide rods. For example, that is the case when, in order to grip the product, a gripper jaw attached to the gripper arm has to be moved into a position underneath the product to be gripped.

Because the first and second gripper carriages are driven by separate linear motors, which are in turn separately controllable, the first and second gripper arms can therefore also be moved individually. As a result, asymmetrical movement of the two gripper arms is also possible, which can be advantageous, for example, if the products to be gripped are arranged closely adjacent to one another or if one of the two gripper arms can be moved only to a limited extent due to some other spatial factor. Furthermore, the gripped product can also be displaced linearly within the scope of the possible range of movement of the gripper carriages.

Preferably the first and second linear motors are arranged relative to one another in such a way that the first and second sliders are movable in parallel with one another, but in opposite directions, in each case in the direction of the longitudinal axis of the guide rods. In particular, for space-saving reasons, the first and second stators in exemplary embodiments are arranged at least partly in a region in the longitudinal direction of the guide rods between the first gripper carriage and the second gripper carriage.

In accordance with a further aspect of the device according to the invention, the at least two guide rods are hollow and have a circular cross-sectional profile. At least the first gripper carriage and optionally also the second gripper carriage is arranged on the at least two guide rods by means of plain bearings.

Hollow guide rods are advantageous for weight-saving reasons and also for reasons of cost. A more lightweight device can be moved more easily and requires less force and energy. Guide rods having a circular cross-sectional profile can be produced cost-effectively with high precision in comparison with guide rods having a different cross-sectional profile and, in addition, they exhibit a high degree of stability.

An arrangement of the gripper carriages on the guide rods by means of plain bearings has the advantage that plain bearings are easy to clean. Each of the plain bearings advantageously comprises at least one layer of an abrasion-resistant plastics.

In accordance with a further aspect of the device according to the invention, a first gripper jaw is attached to the first gripper arm and a second gripper jaw is attached to the second gripper arm. The first gripper jaw and the second gripper jaw each consist of a non-corrosive material, in particular non-corrosive plastics.

The gripper jaws provide simple gripping of the product to be gripped. A non-corrosive plastics as the material from which the gripper jaws are made has the advantage that the gripper jaws have a relatively low mass, which means that the total mass of the respective gripper arm to be moved is kept low. Moreover, gripper jaws made of plastics are cost-effective to produce, which is advantageous in that gripper jaws are typically interchangeable and can be matched in size and shape in accordance with the application.

The gripper jaws can comprise, for example, jaw members which can be moved under the product to be gripped. In that case not only is the product held by means of frictional forces between the gripper jaws and the product, but in addition the product is lifted and supported on its underside.

In accordance with a further aspect of the device according to the invention, the first gripper arm and the second gripper arm are each configured as one or more rods.

A configuration of the gripper arm as (only) one rod has the advantage that costs and weight can be saved. A configuration of the gripper arm as a plurality of rods has the advantage that such a gripper arm is more stable against torsion if, during the gripping operation, forces act decentrally on the gripper jaw and generate a torque acting on the gripper arm. The respective gripper arm can especially be configured as two rods.

In accordance with a further aspect of the device according to the invention, the first gripper arm or the second gripper arm, or both, comprise a force sensor for measuring a force acting on the respective gripper arm in the longitudinal direction of the at least two guide rods.

By means of the force sensor or force sensors, the force exerted on the product being gripped can be measured, and the force exerted on the product being gripped can be adjusted to a predefined value by appropriate control of the linear motors. This is particularly advantageous in the food products sector, because most food products are sensitive to mechanical forces. For measuring the force by means of the force sensor, the gripper arms can be configured as shear beams or as bending beams. Unlike measurement of the force by force sensors arranged in the gripper jaws, the arrangement of the force sensors in the gripper arms is advantageous in that the gripper jaws can be of interchangeable construction, so that if the gripper jaws are exchanged it is unnecessary also to exchange the respective force sensor.

The gripper jaws can therefore be of simple and cost-effective construction. For measurement of the force exerted on the product when the gripping operation is complete, it is in principle sufficient for only one of the gripper arms to be equipped with a force sensor. An arrangement of a force sensor in each of the gripper arms is advantageous in that the force on the gripper arms can be measured even before the gripping operation has been fully completed, that is to say before the gripper arms have completely closed, especially if initially only one of the gripper arms comes into contact with the product to be gripped. Depending upon the measured force, the first linear motor or the second linear motor can then be controlled appropriately during the gripping operation.

In accordance with a further aspect of the device according to the invention, the device further comprises at least one mounting block for mounting the device on a transport device. The at least two guide rods are also fixedly connected to one another by the at least one mounting block.

Typically, after being gripped, the product is also transported. Using the gripping device alone, this is possible in the longitudinal direction of the guide rods (that is to say within the scope of the possible range of movement of the gripper carriages). By means of the mounting block, however, the gripping device can additionally also be mounted on a transport device, thereby allowing movement of the gripping device and accordingly allowing transport of the gripped products to a considerably greater extent and also in other directions. The fixed connection of the guide rods by means of the mounting block firstly ensures that the force of the transport device acts on all guide rods and not only on a single guide rod, with the result that the force is distributed to all guide rods. Moreover, in this way further connection elements for fixedly connecting the at least two guide rods are largely unnecessary.

In accordance with a further aspect of the device according to the invention, the first stator of the first linear motor and the second stator of the second linear motor are each arranged in the longitudinal direction of the at least two guide rods and in parallel with one another and are fixedly connected to the at least two guide rods in such a way that the first stator and the second stator at least partly overlap in the longitudinal direction of the at least two guide rods. The at least one mounting block has only a single mounting block and both the first stator and the second stator are fixedly connected to the at least two guide rods by means of the single mounting block.

The arrangement of the first stator and the second stator so that they overlap in the longitudinal direction of the guide rods, with both stators being fixedly connected to the guide rods by the single mounting block, enables the gripping device to have a space-saving design. Here too, “fixedly connected” means that, by means of the mounting block, the two stators are not movable relative to the guide rods, but are in principle adjustable in respect of the position in the longitudinal direction of the guide rods at which the stators are connected to the guide rods (by the mounting block). Correspondingly, the position at which the two stators are fixedly connected to the guide rods in the longitudinal direction of the guide rods can be adjusted so that the positions of the gripper arms are matched to the size or dimensions of the product to be gripped.

In accordance with a further aspect of the device according to the invention, the first stator of the first linear motor and the second stator of the second linear motor are each arranged in the longitudinal direction of the at least two guide rods and in parallel with one another and are fixedly connected to the at least two guide rods in such a way that the first stator and the second stator are spaced apart from one another in the longitudinal direction of the at least two guide rods. The at least one mounting block has a first mounting block and a second mounting block which is different from the first mounting block. The first stator is fixedly connected to the at least two guide rods by means of the first mounting block and the second stator is fixedly connected to the at least two guide rods by means of the second mounting block.

Such an arrangement of the stators proves advantageous for gripping products of a size that does not allow the first and second linear motors to be attached to a single mounting block, because otherwise the necessary stroke of the linear motors would be very large and correspondingly large (and therefore expensive) linear motors would be required. As a result of the two mutually spaced different mounting blocks, that is to say the first mounting block, by means of which the first stator (of the first linear motor) is connected to the guide rods, and the second mounting block, by means of which the second stator (of the second linear motor) is connected to the guide rods, it is possible to use smaller (and therefore less expensive) linear motors having a smaller stroke. Furthermore, the fixed connection of the two guide rods to one another by means of both the first mounting block and the second mounting block is also advantageous with regard to a high degree of stability.

In accordance with a further aspect of the device according to the invention, the first slider of the first linear motor is movable out of an arrangement in which it is retracted into the first stator into an arrangement in which it has moved out of the first stator and back into the retracted arrangement again, and the second slider of the second linear motor is movable out of an arrangement in which it is retracted into the second stator into an arrangement in which it has moved out of the second stator and back into the retracted arrangement again, in such a way that during the movement of the first and second sliders out of the first stator and out of the second stator, respectively, the first gripper carriage and the second gripper carriage are moved away from one another.

In this arrangement, the two stators (the first and the second stator) of the two linear motors (of the first linear motor and of the second linear motor) can be arranged at least partly between the two gripper carriages in the longitudinal direction of the guide axes and therefore in a space-saving way.

In accordance with a further aspect of the device according to the invention, the first or the second linear motor, or both, are tubular linear motors.

A tubular linear motor has, in cross-section, a stator of circular-cylindrical hollow profile and a slider of corresponding circular-cylindrical outer profile. Tubular linear motors are linear motors that are simple and reliable to produce and have a high degree of stability. They are standard in many applications of linear motors.

In accordance with a further aspect of the device according to the invention, the first gripper carriage or the second gripper carriage, or both, comprise a recess which extends in the longitudinal direction of the at least two guide rods. The recess is arranged on the first gripper carriage or on the second gripper carriage on a respective side that faces towards the first stator of the first linear motor.

In the case where the first gripper carriage or the second gripper carriage overlaps the first stator in the longitudinal direction of the at least two guide rods, the recess partly surrounds the first stator in order to prevent the first gripper carriage or the second gripper carriage from making contact with the first stator.

In accordance with a further aspect of the device according to the invention, the first gripper carriage or the second gripper carriage, or both, comprise a further recess which extends in the longitudinal direction of the at least two guide rods. The further recess is arranged on the first gripper carriage or on the second gripper carriage on a respective further side that faces towards the second stator of the second linear motor.

In the case where the first gripper carriage or the second gripper carriage overlaps the second stator in the longitudinal direction of the at least two guide rods, the further recess partly surrounds the second stator in order to prevent the first gripper carriage or the second gripper carriage from making contact with the second stator.

The recess and/or the further recess enables the gripping device to have a compact structure. In particular, the respective recess allows an arrangement in which the respective stator (that is to say the first stator or the second stator, or both) is arranged so as to overlap the guide rods in a direction perpendicular to the longitudinal direction of the guide rods and, for example, projects partly between the at least two guide rods. Such an arrangement is, in addition, advantageous for the transmission of force from the slider to the gripper carriage, because the lever arm for transmission of the force from the respective slider to the associated gripper carriage is thereby minimised (that is to say the point at which the respective slider acts upon the respective gripper carriage is as central as possible). Correspondingly, any torque acting on the associated gripper carriage due to the eccentric action of the slider is also minimised, thereby protecting the plain bearings of the respective gripper carriage and also reducing the risk of canting of the respective gripper carriage on the guide rods.

In accordance with a further aspect of the device according to the invention, the first stator, or the second stator, or both, are each positionable at various positions in the longitudinal direction of the at least two guide rods. The respective stator is fixedly connected to at least one of the at least two guide rods at one of the various positions.

This has the advantage that the device can be adapted to different sizes and dimensions of the products to be gripped, without it being necessary to exchange the linear motors. In production lines in which food products of different sizes are produced or processed, it is accordingly necessary to install only one gripping device, which can easily be adapted to products of different sizes and dimensions.

As already mentioned, the second gripper carriage can be arranged so as to be movable in the longitudinal direction along the at least two guide rods. In accordance with a further aspect of the device according to the invention, however, the second gripper carriage is fixedly arranged on the at least two guide rods.

In exemplary embodiments in which the second gripper carriage is fixedly arranged on the at least two guide rods, only one linear motor (that is to say the first linear motor for moving the first gripper carriage) is necessary. As a result, costs and weight can be saved, with the result that the gripping device can be moved more quickly and in a more energy-saving manner by a corresponding transport device.

In accordance with a further aspect of the device according to the invention, the first gripper arm or the second gripper arm, or both, are of two-part construction. A first part of the two-part gripper arm comprises the force sensor. A second part of the two-part gripper arm has an arm extension which is detachably connected to the first part.

That two-part construction of the gripper arm has the advantage that the second part of the gripper arm, by which the length of the gripper arm is ultimately determined, can be of simple and cost-effective construction and can be exchanged in order to form gripper arms of different lengths, while the first part having the force sensors need not be exchanged.

In accordance with a further aspect of the device according to the invention, the device further comprises
a third gripper carriage having a third gripper arm attached thereto, and
a fourth gripper carriage having a fourth gripper arm attached thereto.

The third and fourth gripper carriages consist of a non-corrosive material, in particular non-corrosive plastics, and the third and fourth gripper arms likewise each consist of a non-corrosive material, in particular stainless steel. The third and fourth gripper carriages are each arranged on the at least two guide rods, and at least the third gripper carriage is movable along the at least two guide rods. The first and second gripper carriages and the third and fourth gripper carriages are arranged in associated pairs on the at least two guide rods. The device further comprises
a third, in particular tubular, linear motor, comprising
a third stator, which is fluid-tightly enclosed by a casing made of a non-corrosive material, in particular stainless steel, and
a third slider arranged so as to be movable relative to the third stator, which third slider has a fluid-tight slider tube made of a non-corrosive material, in particular stainless steel, in which permanent magnets are arranged.

The third slider is fixedly connected to the third gripper carriage and the third stator is fixedly connected to at least one of the at least two guide rods, for movement of the third gripper carriage along the at least two guide rods by movement of the third slider relative to the third stator.

This has the advantage that two products can be gripped and transported by the device simultaneously.

In accordance with a further aspect of the device according to the invention, the fourth gripper carriage is also movable along the at least two guide rods, and the device further comprises a fourth, in particular tubular, linear motor. The fourth linear motor comprises
a fourth stator, which is fluid-tightly enclosed by a casing made of a non-corrosive material, in particular stainless steel, and
a fourth slider arranged so as to be movable relative to the fourth stator, which fourth slider has a fluid-tight slider tube made of a non-corrosive material, in particular stainless steel, in which permanent magnets are arranged.

The fourth slider is fixedly connected to the fourth gripper carriage and the fourth stator is fixedly connected to at least one of the at least two guide rods, for movement of the fourth gripper carriage along the at least two guide rods by movement of the fourth slider relative to the fourth stator.

Because both the third and the fourth gripper carriage are movable and are driven by a separate third and fourth linear motor, respectively, the third and fourth gripper arms are also able to move independently of one another. The movability of both the third and the fourth gripper carriages and therefore also of the third and fourth gripper arms enables items to be gripped without it being necessary to move the entire device for gripping the product, as can be the case with a static arrangement of the fourth gripper carriage and therefore of the fourth gripper arm. The comments made hereinabove in relation to the movable second gripper carriage and therefore to the second gripper arm apply correspondingly to the fourth gripper carriage and therefore to the fourth gripper arm.

The system according to the invention for gripping and transporting food products or pharmaceutical products comprises a device for gripping food products or pharmaceutical products, as described above, and a transport device. The device for gripping food products or pharmaceutical products is mounted on the transport device by means of the at least one mounting block.

Such a system offers the same advantages as the device according to the invention for gripping food products or pharmaceutical products, which advantages are not repeated here. By means of the transport device, the product gripped by the gripping device can be transported to a desired location (within the scope of the possible range of movement of the transport device).

Further advantageous aspects and embodiments will be found in the subsequent description of exemplary embodiments of the invention with the aid of the diagrammatic drawings, wherein:

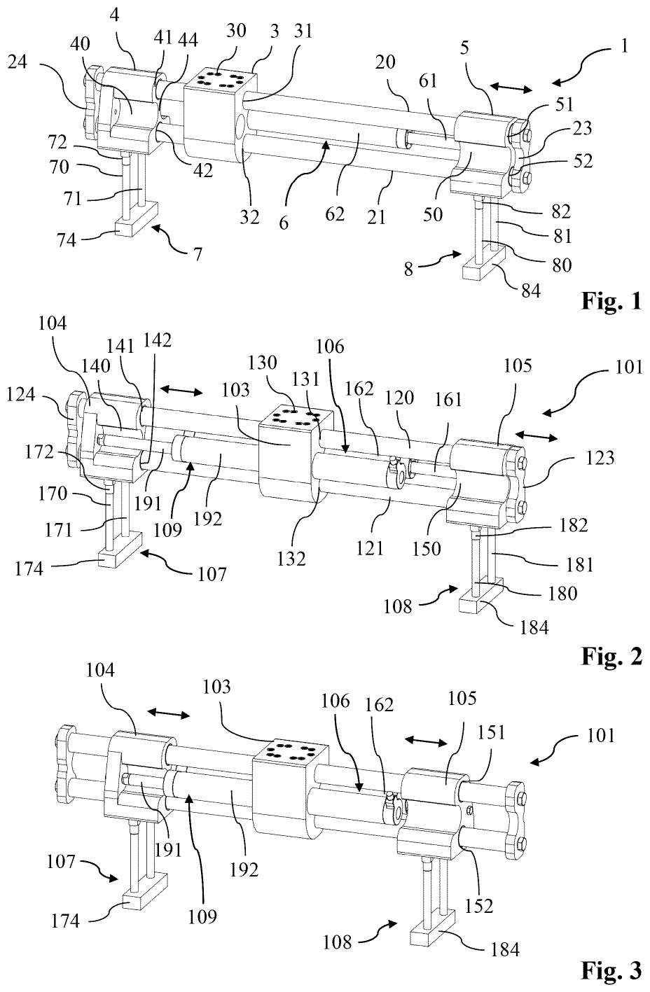

FIG. 1 shows a perspective view of a first exemplary embodiment of the device according to the invention for gripping food products;

FIG. 2 shows a perspective view of a second exemplary embodiment of the device according to the invention with a first arrangement of the first and second gripper carriages;

FIG. 3 shows a perspective view of the second exemplary embodiment of the device according to the invention with a second arrangement of the first and second gripper carriages;

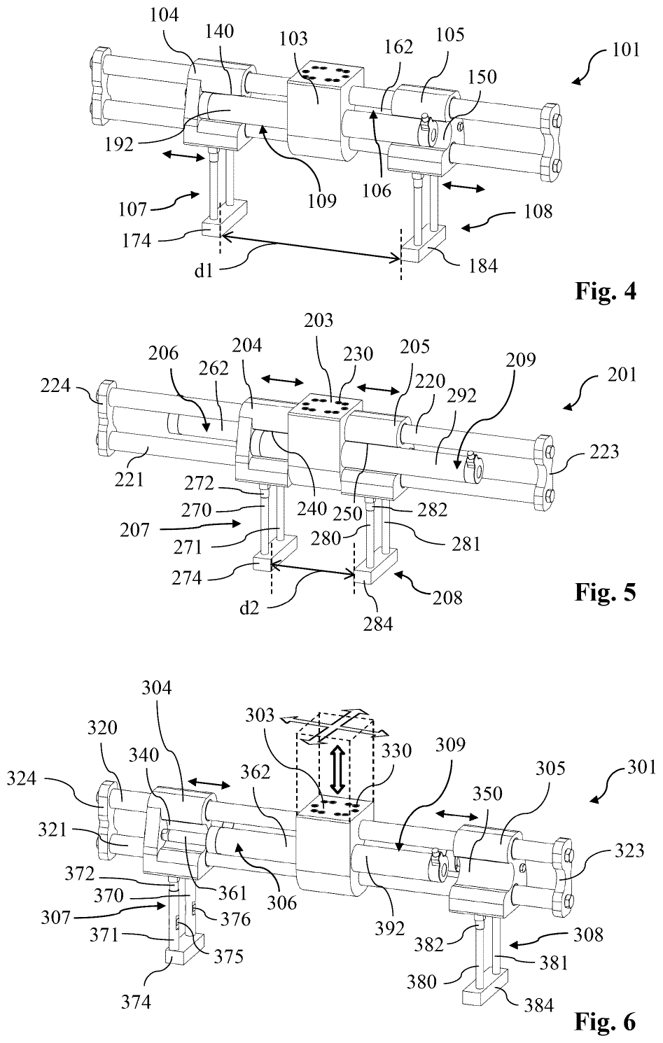

FIG. 4 shows a perspective view of the second exemplary embodiment of the device according to the invention with a third arrangement of the first and second gripper carriages;

FIG. 5 shows a perspective view of a third exemplary embodiment of the device according to the invention;

FIG. 6 shows a perspective view of a fourth exemplary embodiment of the device according to the invention as part of a system according to the invention for gripping and transporting food products;

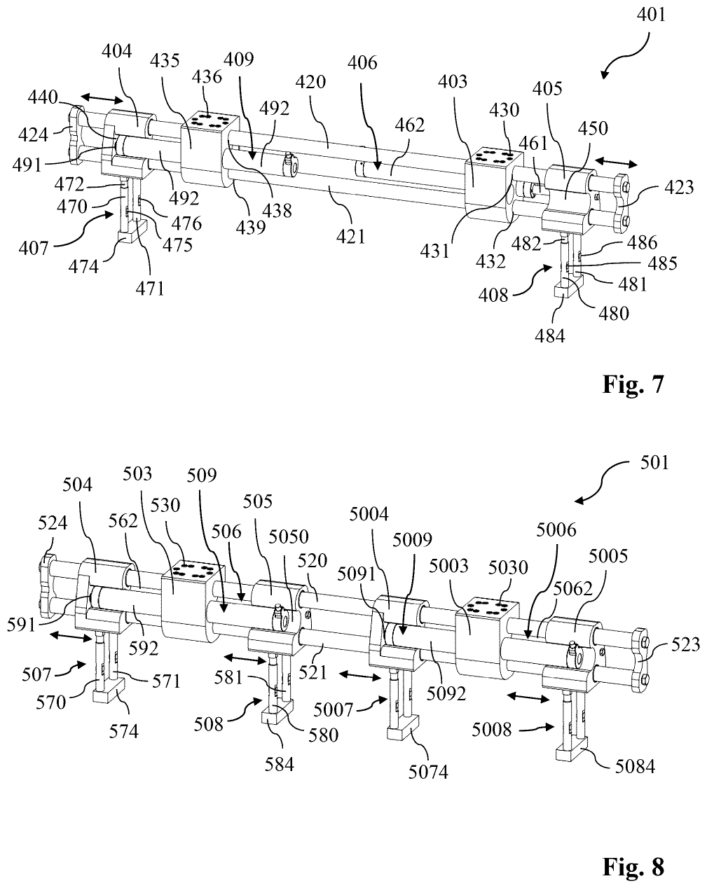

FIG. 7 shows a perspective view of a fifth exemplary embodiment of the device according to the invention;

FIG. 8 shows a perspective view of a sixth exemplary embodiment of the device according to the invention;

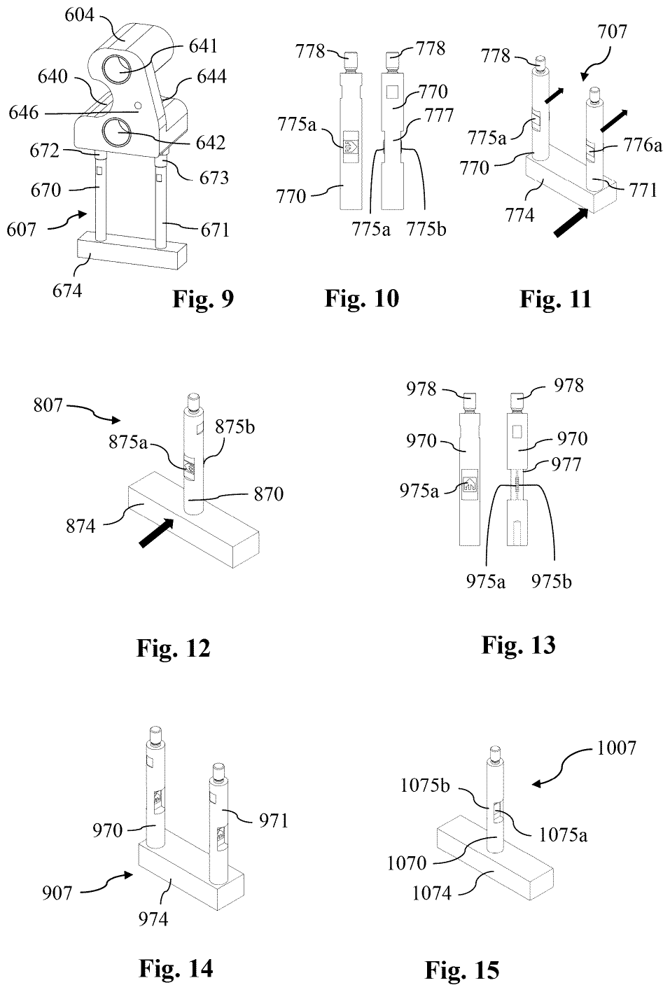

FIG. 9 shows a perspective view of a gripper carriage with gripper arm;

FIG. 10 shows a front view and a side view of a rod of a gripper arm;

FIG. 11 shows a perspective view of a gripper arm with two rods according to FIG. 10 and a gripper jaw attached thereto;

FIG. 12 shows a perspective view of a further gripper arm with only one rod according to FIG. 10 and a gripper jaw attached thereto;

FIG. 13 shows a front view and a side view of a further rod of a gripper arm;

FIG. 14 shows a perspective view of a gripper arm with two rods according to FIG. 13 and a gripper jaw attached thereto;

FIG. 15 shows a perspective view of a gripper arm with only one rod according to FIG. 13 and a gripper jaw attached thereto;

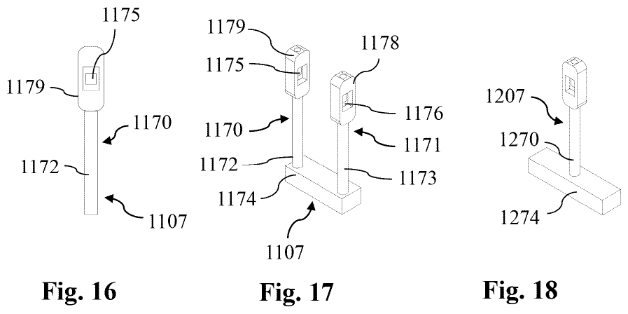

FIG. 16 shows a side view of a rod of a gripper arm of two-part construction;

FIG. 17 shows a perspective view of a gripper arm of two-part construction with two rods according to FIG. 16 and a gripper jaw attached thereto; and

FIG. 18 is a perspective view of a gripper arm of two-part construction with only one rod according to FIG. 16 and a gripper jaw attached thereto.

FIG. 1 shows a first exemplary embodiment of a device 1 according to the invention for gripping food products. The device 1 comprises two straight guide rods 20, 21 made of stainless steel which are fixedly connected to one another and arranged in parallel and one above the other. Both guide rods 20, 21 are hollow and have a circular cross-sectional profile. The two guide rods 20, 21 are fixedly connected to one another by way of a mounting block 3, the first guide rod 20 being fixedly arranged in a first opening 31 in the mounting block 3 and the second guide rod 21 being fixedly arranged in a second opening 32 in the mounting bock 3. The mounting block 3 has, in addition, mounting holes 30 for mounting the device on a transport device. In addition, the two guide rods 20, 21 are connected to one another at their longitudinal ends, in each case by a clip 23, 24, for additional stabilisation of the guide rods 20, 21.

On the guide rods 20, 21 there are arranged a first gripper carriage 5 and a second gripper carriage 4. Both gripper carriages (that is to say both the first gripper carriage 5 and the second gripper carriage 4) have been produced from polyoxymethylene (POM). The second gripper carriage 4 is fixedly connected to the guide rods 20, 21, the first guide rod 20 being received in a first opening 41 and the second guide rod 21 being received in a second opening 42. The second gripper carriage 4 is in principle positionable at various positions along the guide rods 20, 21, but is fixedly (i.e. immovably) connected to the two guide rods 20, 21 at the particular position. The first gripper carriage 5 is movable along the guide rods 20, 21 (see double-headed arrow). For that purpose, the gripper carriage 5 is arranged on the two guide rods 20, 21 by means of plain bearings which are arranged in two circular openings 51, 52 of the first gripper carriage 5, which openings receive the two guide rods 20, 21.

Furthermore, the device 1 comprises a first, for example tubular, linear motor 6, which has a first stator 62 and a first slider 61 which is arranged so as to be movable relative to the first stator 62. The first stator 62 is fluid-tightly enclosed by a casing made of stainless steel. The first slider 61 has a fluid-tight slider tube made of stainless steel in which permanent magnets (not shown) are arranged. The first slider 61 is fixedly connected to the first gripper carriage 5, and the first stator 62 is fixedly connected to the mounting block 3 and, by means of the mounting block 3, fixedly connected to the guide rods 20, 21. By movement of the first slider 61 relative to the first stator 62, the first gripper carriage 5 can be moved along the two guide rods 20, 21. The first stator 62 is in principle positionable at various positions along the guide rods 20, 21, but is fixedly (i.e. immovably) connected to the two guide rods 20, 21 at the particular position by means of the mounting block 3.

Furthermore, the first gripper carriage 5, on its side that faces away from the first stator 62, comprises a recess 50 which extends in the longitudinal direction of the at least two guide rods. A corresponding further recess is arranged on the opposite side of the first gripper carriage 5, which side faces towards the first stator 62 (not visible in FIG. 1). The second gripper carriage 4 likewise comprises a recess 40 on its side that faces away from the first stator 62, which recess extends in the longitudinal direction of the two guide rods 20, 21. On its side that faces towards the first stator 62, the second gripper carriage likewise has a corresponding further recess 44.

A first gripper arm 8 is attached to the first gripper carriage 5 and a second gripper arm 7 is attached to the second gripper carriage 4. The first gripper arm 8 is configured as two rods 80, 81 which are attached to the first gripper carriage 5 by means of two fixing pins 82 and to which a first gripper jaw 84 is attached. Correspondingly, the second gripper arm 7 is also configured as two rods 70, 71 which are attached to the second gripper carriage 4 by means of two fixing pins 72 and to which a second gripper jaw 74 is attached.

In the arrangement shown in FIG. 1, the first, movable gripper carriage 5 is located in the position of maximum displacement.

FIG. 2 shows a second exemplary embodiment of the device according to the invention for gripping food products having a first arrangement of the first and second gripper carriages. The device 101 shown in FIG. 2 comprises two straight guide rods 120, 121 made of stainless steel which are fixedly connected to one another and arranged in parallel and one above the other. Both guide rods 120, 121 are hollow and have a circular cross-sectional profile. The two guide rods 120, 121 are fixedly connected to one another by way of a mounting block 103, the first guide rod 120 being fixedly arranged in a first opening 131 in the mounting block 3 and the second guide rod 21 being fixedly arranged in a second opening 132 in the mounting block 103. In addition, the two guide rods 120, 121 are connected to one another at their longitudinal ends, in each case by a clip 123, 124, for additional stabilisation of the guide rods 120, 121.

On the guide rods 120, 121 there are arranged a first gripper carriage 105 and a second gripper carriage 104 made of POM. Both the first gripper carriage 105 and the second gripper carriage 104 are each movable along the guide rods 120, 121 (see double-headed arrows). For that purpose, the gripper carriages 104, 105 are arranged on the two guide rods 120, 121 by means of plain bearings, the two guide rods 120, 121 being received in the two circular openings 151, 152 (see FIG. 3) of the first gripper carriage 105, in which the plain bearings of the first gripper carriage 105 are arranged, and in the two circular openings 141, 142 of the second gripper carriage 104, in which the plain bearings of the second gripper carriage 104 are arranged.

Furthermore, the device 101 comprises a first, for example tubular, linear motor 106, which has a first stator 162 and a first slider 161 which is arranged so as to be movable relative to the first stator 162. The first stator 162 is fluid-tightly enclosed by a casing made of stainless steel, and the first slider 161 has a fluid-tight slider tube made of stainless steel in which permanent magnets (not shown) are arranged. Moreover, the device 101 comprises a second, for example tubular, linear motor 109, which is identical in construction to the first linear motor 106 and has a second stator 192 as well as a second slider 191 which is movable relative to the second stator 192.

The first slider 161 of the first linear motor 106 is fixedly connected to the first gripper carriage 105 and the second slider 191 of the second linear motor 109 is fixedly connected to the second gripper carriage 104. Both the first stator 162 of the first linear motor 106 and the second stator 192 of the second linear motor 109 are each fixedly connected to the guide rods 120, 121 by means of the mounting block 103. They are each arranged in the longitudinal direction of the at least two guide rods 120, 121 and in parallel with one another, the first stator 162 and the second stator 192 overlapping (even completely in FIG. 2) in the longitudinal direction of the two guide rods 120, 121. By movement of the first slider 161 relative to the first stator 162, the first gripper carriage 105 can therefore be moved along the two guide rods 120, 121. Correspondingly, by movement of the second slider 191 relative to the second stator 192, the second gripper carriage 104 can be moved along the two guide rods 120, 121.

Both the first stator 162 and the second stator 192 are in principle each positionable at various positions along the guide rods 120, 121. At their particular positions, however, the first stator 162 and the second stator 192 are each fixedly connected to the two guide rods 120, 121 by means of the mounting block 103.

Both the first gripper carriage 105 and the second gripper carriage 104 each comprise a recess which extends in the longitudinal direction of the at least two guide rods 120, 121, which recess is arranged on the first gripper carriage or on the second gripper carriage on a side that faces towards the first stator 162 of the first linear motor 106. Correspondingly, the first gripper carriage 105 and the second gripper carriage 104 comprise a further recess 150, 140, which is arranged on the first gripper carriage 105 or on the second gripper carriage 104 on the respective side which faces towards the second stator 192 of the second linear motor 109.

A first gripper arm 108 is attached to (fixedly arranged on) the first gripper carriage 105 and a second gripper arm 107 is attached to (fixedly arranged on) the second gripper carriage 104. The first gripper arm 108 is configured as two rods 180, 181 which are attached to the first gripper carriage 105 by means of two fixing pins 182 and to which a first gripper jaw 184 is attached. Correspondingly, the second gripper arm 107 is also configured as two rods 170, 171 which are attached to the second gripper carriage 104 by means of two fixing pins 172 and to which a second gripper jaw 174 is attached.

In the arrangement shown in FIG. 2, both the first gripper carriage 105 and the second gripper carriage 104 are each located in a position of maximum displacement.

FIG. 3 shows the exemplary embodiment of the device according to the invention shown in FIG. 2 with a second arrangement of the first gripper carriage 105 and of the second gripper carriage 104. In this arrangement, the first slider 161 is in a position relative to the first stator 162 of the first linear motor 106 and the second slider 191 is in a position relative to the second stator 192 of the second linear motor 109 in which the slider has in each case been partly retracted into the respective stator 162, 192. In comparison with the arrangement shown in FIG. 2, the first gripper carriage 105 and the second gripper carriage 104 have been moved towards one another. Accordingly, the gripper arms 107, 108 attached to the respective gripper carriages 104, 105 and therefore the gripper jaws 174, 184 that are in turn attached to the gripper arms 107, 108 have also been moved towards one another.

FIG. 4 shows the exemplary embodiment of the device according to the invention shown in FIGS. 2 and 3 with a third arrangement of the first gripper carriage 105 and of the second gripper carriage 104. In this third arrangement, the two sliders 161, 191 are located in an arrangement in which they are fully retracted into the respective stators 162, 192. In this arrangement, the first gripper carriage 105 and the second gripper carriage 104 partly overlap the first stator 162 and the second stator 192 in the longitudinal direction. On a side that faces towards the second stator 192, the further recess 150 of the second gripper carriage 105 partly surrounds the second stator 192, with the result that contact between the second gripper carriage 105 and the second stator 192 is avoided. The recess arranged on the side of the first gripper carriage 105 that faces towards the first stator 162 at least partly surrounds the first stator 162, with the result that contact between the first gripper carriage 105 and the first stator 162 is avoided also on the side of the first gripper carriage 105 that faces towards the first stator 162. On a side that faces towards the second stator 192, the further recess 140 of the second gripper carriage 104 partly surrounds the second stator 192, with the result that contact between the second gripper carriage 104 and the second stator 192 is also avoided. The recess arranged on the side of the second gripper carriage 104 that faces towards the first stator 162 at least partly surrounds the first stator 162, with the result that contact between the second gripper carriage 104 and the first stator 162 is avoided also on the side of the second gripper carriage 104 that faces towards the first stator 162.

In the arrangement shown in FIG. 4, the gripper carriages 104, 105 and accordingly also the gripper arms 107, 108 are the smallest distance apart. In this arrangement the two gripper jaws 174 are a minimum distance d1 apart.

FIG. 5 shows a third exemplary embodiment of the device 201 according to the invention for gripping food products. The device 201 comprises two straight guide rods 220, 221 which are fixedly connected to one another and arranged in parallel and one above the other, which guide rods are identical in construction to the guide rods described in the two preceding exemplary embodiments and which are fixedly connected to one another by way of a mounting block 203, the first guide rod 220 being fixedly arranged in a first opening in the mounting block 203 and the second guide rod 221 being fixedly arranged in a second opening in the mounting block 203. In addition, the two guide rods 220, 221 are connected to one another at their longitudinal ends, in each case by a clip 223, 224.

On the guide rods 220, 221 there are arranged a first gripper carriage 205 and a second gripper carriage 204 made of POM. Both the first gripper carriage 205 and the second gripper carriage 204 are movable along the guide rods 220, 221 (see double-headed arrows). The gripper carriages 204, 205 are arranged on the two guide rods 220, 21 by means of plain bearings, as is also the case in the first two exemplary embodiments and has already been described above.

Furthermore, the device 201 comprises a first, for example tubular, linear motor 206, which has a first stator 262 and a first slider 261 which is arranged so as to be movable relative to the first stator 262. Moreover, the device 201 comprises a second, for example tubular, linear motor 209, which has a second stator 292 as well as a second slider 291 which is movable relative to the first stator 292. The two linear motors 206, 209 are identical in construction to the linear motors 6, 106, 109 described in the first two exemplary embodiments.

The first slider of the first linear motor 206 is fixedly connected to the first gripper carriage 205, and the second slider 291 of the second linear motor 209 is fixedly connected to the second gripper carriage 204. Both the first stator 262 of the first linear motor 206 and the second stator 292 of the second linear motor 209 are each fixedly connected to the mounting block 203 and, by means of the mounting block 203, fixedly connected to the guide rods 220, 221. They are each arranged in the longitudinal direction of the at least two guide rods 220, 221 and in parallel with one another, the first stator 262 and the second stator 292 overlapping (here only partly) in the longitudinal direction of the two guide rods 220, 221. By movement of the first slider 261 relative to the first stator 262, the first gripper carriage 205 can be moved along the two guide rods 220, 221. Correspondingly, by movement of the second slider 291 relative to the second stator 292, the second gripper carriage 204 can be moved along the two guide rods 220, 221.

Both the first stator 262 and the second stator 292 are in principle positionable at various positions in the longitudinal direction of the guide rods 220, 221. At their particular positions, however, both the first stator 262 and the second stator 292 are each fixedly connected to the two guide rods 220, 221 by means of the mounting block 203.

Both the first gripper carriage 205 and the second gripper carriage 204 each comprise a recess which extends in the longitudinal direction of the at least two guide rods 220, 221 and which is arranged on the first gripper carriage 205 and on the second gripper carriage 204, respectively, on a side that faces towards the first stator 262 of the first linear motor 206. Correspondingly, the first gripper carriage 205 and the second gripper carriage 204 each comprise a further recess 250, 240, respectively, which is arranged on the first gripper carriage 205 or on the second gripper carriage 204 on a side that faces towards the second stator 292 of the second linear motor 209.

A first gripper arm 208 is attached to (fixedly arranged on) the first gripper carriage 205 and a second gripper arm 207 is attached to (fixedly arranged on) the second gripper carriage 204. The first gripper arm 208 is configured as two rods 280, 281 which are attached to the first gripper carriage 205 by means of two fixing pins 282 and to which a first gripper jaw 284 is attached. Correspondingly, the second gripper arm 207 is also configured as two rods 270, 271 which are attached to the second gripper carriage 204 by means of two fixing pins 272 and to which a second gripper jaw 274 is attached.

In the arrangement shown in FIG. 5, both the first gripper carriage 205 and the second gripper carriage 204 are each located in a minimally displaced position. Unlike the second exemplary embodiment of the device according to the invention shown in FIG. 4, the first stator 262 of the first linear motor 206 and the second stator 292 of the second linear motor 209 are arranged offset with respect to one another in the longitudinal direction of the two guide rods 220, 221, so that they only partly overlap in the longitudinal direction. As a result, the gripper jaws 274, 284 are a minimum distance d2 apart, which is smaller than the minimum distance d1 of the corresponding gripper jaws 174, 184 in the second exemplary embodiment of the device according to the invention.

FIG. 6 shows a fourth exemplary embodiment of the device 301 according to the invention for gripping food products which, as part of a system for gripping and transporting food products, is attached to a transport device (shown by dashed lines). The fourth exemplary embodiment of the device 301 according to the invention shown in FIG. 6 corresponds substantially to the second exemplary embodiment of the device 101 according to the invention shown in FIGS. 2 to 4, apart from a force sensor described hereinbelow. Corresponding reference numerals have therefore each been increased by two hundred with respect to the second exemplary embodiment described in FIGS. 2 to 4 (although they are not described in detail below).

The two rods 370, 371 of the second gripper arm 307 each have a force sensor 375, 376 for measuring a force acting on the second gripper arm 307 in the longitudinal direction of the guide rods 320, 321. The arrangement shown here corresponds to a bending beam arrangement.

The device 301 is attached to the transport device indicated by the dashed lines by means of the mounting block 303. The mounting block 303 comprises a plurality of mounting holes 330, by means of which the mounting block 303 is attached to the transport device. With the transport system, the device 301 is able to travel both laterally (indicated by the crossed double-headed arrows) and vertically (likewise indicated by a corresponding double-headed arrow).

FIG. 7 shows a fifth exemplary embodiment of the device 401 according to the invention for gripping food products. The device 401 comprises two straight guide rods 420, 421 made of stainless steel which are fixedly connected to one another and arranged in parallel and one above the other. Both guide rods 420, 421 are hollow and have a circular cross-sectional profile. The two guide rods 420, 421 are fixedly connected to one another by way of a first mounting block 403 and a second mounting block 435, the first guide rod 420 being fixedly arranged in a first opening 431 in the first mounting block 403 and the second guide rod 421 being fixedly arranged in a second opening 432 in the first mounting block 403. Furthermore, the first guide rod 420 is fixedly arranged in a first opening 438 in the second mounting block 435 and the second guide rod 421 is fixedly arranged in a second opening 439 in the second mounting block 435. In addition, the two guide rods 420, 421 are connected to one another at their longitudinal ends, in each case by a clip 423, 424. Both the first mounting block 403 and the second mounting block 435 are each provided with mounting holes 430, 436 for mounting the device on a transport device.

On the guide rods 420, 421 there are arranged a first gripper carriage 405 and a second gripper carriage 404 made of POM. Both the first gripper carriage 405 and the second gripper carriage 404 are movable along the guide rods 420, 421 (see double-headed arrows). The gripper carriages 404, 405 are arranged on the two guide rods 420, 421 by means of plain bearings, as in the case of the exemplary embodiments described above.

Furthermore, the device 401 comprises a first, for example tubular, linear motor 406, which has a first stator 462 and a first slider 461 which is arranged so as to be movable relative to the first stator 462. Moreover, the device 401 has a second, for example tubular, linear motor 409 which is identical in construction to the first linear motor 406 and has a second stator 492 as well as a second slider 491 which is movable relative to the first stator 492. The two linear motors 406, 409 are identical in construction to the linear motors described in the first four exemplary embodiments.

The first slider 461 of the first linear motor 406 is fixedly connected to the first gripper carriage 405 and the second slider 491 of the second linear motor 409 is fixedly connected to the second gripper carriage 404. The first stator 462 of the first linear motor 406 is fixedly connected to the first mounting block 403 and, by means of the first mounting block 403, fixedly connected to the guide rods 420, 421 and arranged in the longitudinal direction of the at least two guide rods 420, 421. The second stator 492 of the second linear motor 409 is fixedly connected to the second mounting block 435 and, by means of the second mounting block 435, fixedly connected to the guide rods 420, 421 and likewise arranged in the longitudinal direction of the at least two guide rods 420, 421 and in parallel with the first stator 462 of the first linear motor 406. The first stator 462 and the second stator 492 do not overlap in the longitudinal direction of the two guide rods 420, 421 but are arranged spaced apart from one another in the longitudinal direction of the two guide rods 402, 420. By movement of the first slider 461 relative to the first stator 462, the first gripper carriage 405 can be moved along the two guide rods 420, 421. Correspondingly, by movement of the second slider 491 relative to the second stator 492, the second gripper carriage 404 can be moved along the two guide rods 420, 421.

Both the first stator 462 and the second stator 492 are in principle positionable at various positions in the longitudinal direction of the guide rods 420, 421. At its particular position, however, the first stator 462 is fixedly connected to the two guide rods 420, 421 by means of the first mounting block 403, and the second stator 492 is likewise fixedly connected to the two guide rods 420, 421 at its particular position by means of the second mounting block 435.

Both the first gripper carriage 405 and the second gripper carriage 404 each comprise a recess which extends in the longitudinal direction of the at least two guide rods 420, 421, which recess is arranged on the first gripper carriage or on the second gripper carriage on a respective side that faces towards the first stator 462 of the first linear motor 406. Correspondingly, the first gripper carriage 405 and the second gripper carriage 404 each comprise a further recess 450, 440, respectively, which is arranged on the respective side of the first gripper carriage 405 or of the second gripper carriage 404 and which faces towards the second stator 492 of the second linear motor 409.

A first gripper arm 408 is attached to the first gripper carriage 405 and a second gripper arm 407 is attached to the second gripper carriage 404. The first gripper arm 408 is configured as two rods 480, 481 which are attached to the first gripper carriage 405 by means of two fixing pins 482 and to which a first gripper jaw 484 is attached. Correspondingly, the second gripper arm 407 is also configured as two rods 470, 471 which are attached to the second gripper carriage 404 by means of two fixing pins 472 and to which a second gripper jaw 474 is attached.

The two rods 470, 471 of the second gripper arm 407 each have a force sensor 475, 476 for measuring a force acting on the second gripper arm 407 in the longitudinal direction of the guide rods 420, 421. The two rods 480, 481 of the first gripper arm 408 also each have a force sensor 485, 486 for measuring a force acting on the first gripper arm 408 in the longitudinal direction of the guide rods 420, 421. The arrangements of the force sensors 475, 476, 485, 486 shown here each correspond to a bending beam arrangement.

In the exemplary embodiment shown in FIG. 7, the spacing between the two gripper jaws 474, 484 is significantly larger than in the two preceding exemplary embodiments. This makes it possible to grip products having significantly larger dimensions than in the previously described exemplary embodiments.

FIG. 8 shows a sixth exemplary embodiment of the device 501 according to the invention for gripping food products. The device 501 comprises two straight guide rods 520, 521 made of stainless steel which are fixedly connected to one another and arranged in parallel and one above the other. Both guide rods 520, 521 are hollow and have a circular cross-sectional profile. The two guide rods 520, 521 are fixedly connected to one another by way of a first mounting block 503 and a second mounting block 5003, the two guide rods 520, 521 being fixedly arranged in the first mounting block 503 and the second mounting block 5003 in the manner already described for the exemplary embodiments explained above. In addition, the two guide rods 520, 521 are connected to one another at their ends, in each case by a clip 523, 524.

On the guide rods 520, 521 there are arranged a first gripper carriage 505 and a second gripper carriage 504, which are each identical in construction to the gripper carriages 405, 404 described in the preceding exemplary embodiments. Both the first gripper carriage 505 and the second gripper carriage 504 are movable along the guide rods 420, 421 (see double-headed arrows). The gripper carriages 504, 505 are arranged on the two guide rods 520, 521 by means of plain bearings, as in the case of the exemplary embodiments described above wherein both gripper carriages are movable.

Furthermore, the device 501 comprises a first, for example tubular, linear motor 506, which has a first stator 562 and a first slider 561 (not visible) which is arranged so as to be movable relative to the first stator 562. Moreover, the device 501 comprises a second, for example tubular, linear motor 509, which is identical in construction to the first linear motor 506 and has a second stator 592 as well as a second slider 591 which is movable relative to the first stator 592. The two linear motors 506, 509 are identical in construction to the linear motors in the exemplary embodiments described above wherein both gripper carriages are movable.

The slider 561 of the first linear motor 506 is fixedly connected to the first gripper carriage 505 and the second slider 591 of the second linear motor 509 is fixedly connected to the second gripper carriage 504. Both the first stator 562 and the second stator 592 are fixedly connected to the first mounting block 503 and, by means of the mounting block 503, fixedly connected to the guide rods 520, 521 and are each arranged in the longitudinal direction of the at least two guide rods 520, 521 and in parallel with one another. The first stator 562 and the second stator 592 overlap in the longitudinal direction of the two guide rods 520, 521. By movement of the first slider 561 relative to the first stator 562, the first gripper carriage 505 can be moved along the two guide rods 520, 521. Correspondingly, by movement of the second slider 591 relative to the second stator 592, the second gripper carriage 504 can be moved along the two guide rods 520, 521.

A first gripper arm 508 is attached to the first gripper carriage 505 and a second gripper arm 507 is attached to the second gripper carriage 504. The gripper arms 507, 508 are each identical in construction to the gripper arms 407, 408 described in the preceding exemplary embodiment. A first gripper jaw 584 is attached to the first gripper arm 508, which is configured as two rods 580, 581, and a second gripper jaw 574 is attached to the second gripper arm 507, which is likewise configured as two rods 570, 571.

On the guide rods 520, 521 there are additionally arranged a third gripper carriage 5005 and a fourth gripper carriage 5004, which are each identical in construction to the first gripper carriage 505 and the second gripper carriage 504. Both the third gripper carriage 5005 and the fourth gripper carriage 5004 are movable along the guide rods 520, 521 (see double-headed arrows). The gripper carriages 5004, 5005 are arranged on the two guide rods 520, 521 by means of plain bearings, as in the case of the exemplary embodiments described above wherein both gripper carriages are movable.

Furthermore, the device 501 comprises a third, for example tubular, linear motor 5006, which has a third stator 5062 and a third slider 5061 (not visible) which is arranged so as to be movable relative to the third stator 5062. Moreover, the device 501 comprises a fourth, for example tubular, linear motor 5009 which has a fourth stator 5092 as well as a fourth slider 5091 which is movable relative to the fourth stator 5092. The third linear motor 5006 and the fourth linear motor 5009 are identical in construction to the first linear motor 506 and the second linear motor 509, respectively.

The third slider 5061 of the third linear motor 5006 is fixedly connected to the third gripper carriage 5005 and the fourth slider 5091 of the fourth linear motor 5009 is fixedly connected to the fourth gripper carriage 5004. Both the third stator 5062 and the fourth stator 5092 are each fixedly connected to the second mounting block 5003 and, by means of the second mounting block 5003, fixedly connected to the guide rods 520, 521 and arranged in the longitudinal direction of the at least two guide rods 520, 521 and in parallel with one another, the third stator 5062 and the fourth stator 5092 overlapping in the longitudinal direction of the two guide rods 520, 521. By movement of the third slider 5061 relative to the third stator 5062, the third gripper carriage 5005 can be moved along the two guide rods 520, 521. Correspondingly, by movement of the fourth slider 5091 relative to the fourth stator 5092, the fourth gripper carriage 5004 can be moved along the two guide rods 520, 521.

A third gripper arm 5008 is attached to the third gripper carriage 5005 and a fourth gripper arm 5007 is attached to the fourth gripper carriage 5004. The gripper arms 5007, 5008 are each identical in construction to the gripper arms 407, 408 described in the preceding exemplary embodiment. A third gripper jaw 5084 is attached to the third gripper arm 5008 and a fourth gripper jaw 5074 is attached to the fourth gripper arm 5007.

FIG. 9 shows an exemplary embodiment of a gripper carriage 604 with a gripper arm 607 attached thereto, which gripper arm is (apart from the force sensors) substantially identical in construction to the second gripper carriages (or, correspondingly “mirror-imaged”, also identical in construction to the first gripper carriages) of the exemplary embodiments shown in the preceding Figures. The gripper carriage 604 has a first opening 641 and a second opening 642, each having a circular cross-sectional profile, which each extend through the gripper carriage 604 in the longitudinal direction of the guide rods. The gripper carriage 604 comprises a gripper arm 607, which is configured as two rods 670, 671, which are (fixedly) attached to the gripper carriage 604 by way of fixing pins 672, 673. A gripper jaw 674 is attached to the two rods 670, 671. In the exemplary embodiment shown here the gripper jaw 674 is configured as a simple block. In other exemplary embodiments, however, the gripper jaw 674 can also be differently constructed. A force sensor 675, 676 (not shown here) is arranged on each of the two rods 670, 671, respectively. The gripper carriage 604 has a recess 640 which extends in the longitudinal direction of the at least two guide rods, as has already been described above. The recess 640 is arranged on that side of the gripper carriage 604 which faces towards the second stator when the gripper carriage 604 is arranged on the guide rods. A corresponding further recess is arranged on the opposite side that faces towards the first stator when the gripper carriage 604 is arranged on the guide rods. The recess 640 extends over the entire length of the gripper carriage 604, while the recess 644 is bounded by a fixing plate 646 to which the slider of the first linear motor is attached.

FIG. 10 shows an exemplary embodiment of a rod 770 of a gripper arm in a front view and a side view. The rod 770 comprises a mounting pin 778 for fixedly connecting the rod 770 to the gripper carriage by means of the associated fixing pin. The rod 770, which is configured as a bending beam, has a region 777 of reduced thickness in which there are arranged a first strain gauge 775a and, on an opposite side, a second strain gauge 775b which together form the force sensor. The region of reduced thickness serves as a predetermined bending point. As a result of the different elongation of the two strain gauges under the action of a force, the bending of the rod 770 which is configured as a bending beam can be determined with the aid of the two strain gauges 775a, 775b.

FIG. 11 shows an exemplary embodiment of a gripper arm 707 with two rods 770, 771, each rod 770, 771 corresponding to the rod 770 shown in FIG. 10 in terms of its configuration. The two rods 770, 771 are fixedly connected to the gripper jaw 774. With the arrangement shown here, the force acting on the gripper jaw 774 in the longitudinal direction of the guide rods can be determined by means of the known dimensions of the rods 770, 771, which are configured as bending beams. The configuration of the gripper arm 707 as two rods 770, 771 firstly prevents the force measurement with the aid of the strain gauges 775a, 775b, 776a, 776b from being falsified in the event of a product's being gripped in such a way that the force does not act centrally on the gripper jaw 774. Furthermore, by addition of the forces acting on the rods 770, 771 measured by the strain gauges 775a, 776a and by the respectively oppositely arranged associated strain gauges 775b, 776b (which forces are indicated by short black arrows in the drawing), it is possible to determine the total force acting on the gripper jaw 774 (indicated by a long arrow in the drawing).

The signals measured by the strain gauges can then be transmitted to a control unit which evaluates those signals and is able to control the linear motors in a suitable way.

FIG. 12 shows an exemplary embodiment of a gripper arm 807 with only one rod 870, which corresponds to the rod 770 shown in FIG. 10 in terms of its configuration, and which comprises a force sensor formed by two strain gauges 875a, 875b and which is fixedly connected to the gripper jaw 874. The exemplary embodiment shown here is primarily suitable for gripping operations in which the force acts centrally on the gripper jaw 874 (indicated by the long arrow).

FIG. 13 shows an exemplary embodiment of a rod 970 of a gripper arm in a front view and a side view. The rod 970, which is here configured as a shear beam, has a recess 977 in which there are arranged a first strain gauge 975a and, on an opposite side of the recess 977, a second strain gauge 975b, which together form the force sensor. The recess 977 serves as measurement point. The force acting on the rod 970 can be determined on the basis of the shear stress measured by the two strain gauges 975a, 975b.

FIG. 14 shows an exemplary embodiment of a gripper arm with two rods 970, 971, each of the rods 970, 971 corresponding to the rod 970 shown in FIG. 13 in terms of its configuration. The two rods 970, 971 are fixedly connected to the gripper jaw 974.

FIG. 15 shows an exemplary embodiment of a gripper arm 1007 with only one rod 1070 which corresponds to the rod 970 shown in FIG. 13 in terms of its configuration and which comprises a force sensor formed by two strain gauges 1075a, 1075b and is fixedly connected to a gripper jaw 1074.

FIG. 16 shows an exemplary embodiment of a rod 1170 of a gripper arm 1107 of two-part construction. The rod 1170 comprises a first part configured as a connecting element 1179 having an integrated force sensor 1175. Furthermore, the rod 1170 comprises a second part which is configured as an interchangeable extension 1172. The interchangeable extension 1172 is detachably connected to the connecting element 1179.

FIG. 17 shows an exemplary embodiment of a gripper arm 1107 with two rods 1170, 1171, each of the rods 1170, 1171 corresponding to the rod 1170 shown in FIG. 16 in terms of its configuration. The two detachable extensions 1172, 1173 of the rods 1170, 1171 are each fixedly but detachably connected to the gripper jaw 1174. The gripper arm 1107 with the two rods 1170, 1171 and the gripper jaw 1174 attached thereto can be fixedly connected to the corresponding gripper carriage by way of the two connecting elements 1178, 1179, which comprise the respective force sensors 1175, 1176.

FIG. 18 shows an exemplary embodiment of a gripper arm 1207 with only one rod 1270, which corresponds to the rod 870 shown in FIG. 12 in terms of its configuration and is fixedly connected to the gripper jaw 1274.

The gripping device according to the invention and the system according to the invention for gripping and transporting food products have been explained above with reference to exemplary embodiments. However, the invention is not limited to those exemplary embodiments, but is also intended to include those exemplary embodiments which make use of the technical teaching of the invention. The scope of protection is therefore defined by the following patent claims.

1. A device for gripping food products or pharmaceutical products, comprising:
at least two static, straight guide rods comprising stainless steel, which guide rods are fixedly connected to one another and arranged in parallel,
a first gripper carriage having a first gripper arm attached thereto, and
a second gripper carriage having a second gripper arm attached thereto,
wherein the first and second gripper carriages each comprise a non-corrosive material, and the first and second gripper arms comprise a non-corrosive material, wherein the first and second gripper carriages are each arranged on the at least two guide rods, and wherein at least the first gripper carriage is movable along the at least two guide rods, and
a first linear motor, comprising
a first stator, which is fluid-tightly enclosed by a casing comprising a non-corrosive material, and
a first slider arranged so as to be movable relative to the first stator, which first slider has a fluid-tight slider tube comprising a non-corrosive material, in which permanent magnets are arranged, wherein the first slider is fixedly connected to the first gripper carriage and the first stator is fixedly connected to at least one of the at least two guide rods, for movement of the first gripper carriage along the at least two guide rods by movement of the first slider relative to the first stator.

2. The device according to claim 1, wherein the second gripper carriage is also movable along the at least two guide rods, and wherein the device further comprises a second linear motor, the second linear motor comprising
a second stator, which is fluid-tightly enclosed by a casing comprising a non-corrosive material, and
a second slider arranged so as to be movable relative to the second stator, which second slider has a fluid-tight slider tube made of a non-corrosive material, in which permanent magnets are arranged, wherein the second slider is fixedly connected to the second gripper carriage and the second stator is fixedly connected to at least one of the at least two guide rods, for movement of the second gripper carriage along the at least two guide rods by movement of the second slider relative to the second stator.

3. The device according to claim 1, wherein the at least two guide rods are hollow and have a circular cross-sectional profile, and wherein at least the first gripper carriage and optionally also the second gripper carriage is arranged on the at least two guide rods by means of plain bearings.

4. The device according to claim 1, wherein the first gripper arm and the second gripper arm are each configured as one or more rods.

5. The device according to claim 1, wherein either the first gripper arm or the second gripper arm, or both, comprise a force sensor for measuring a force acting on the respective gripper arm in the longitudinal direction of the at least two guide rods.

6. The device according to claim 1, wherein the device further comprises at least one mounting block for mounting the device on a transport device, wherein the at least two guide rods are also fixedly connected to one another by the at least one mounting block.

7. The device according to claim 6, wherein the first stator of the first linear motor and the second stator of the second linear motor are each arranged in the longitudinal direction of the at least two guide rods and in parallel with one another and are fixedly connected to the at least two guide rods in such a way that the first stator and the second stator at least partly overlap in the longitudinal direction of the at least two guide rods, and wherein the at least one mounting block has only a single mounting block and both the first stator and the second stator are fixedly connected to the at least two guide rods by means of the single mounting block.

8. The device according to claim 6, wherein the first stator of the first linear motor and the second stator of the second linear motor are each arranged in the longitudinal direction of the at least two guide rods and in parallel with one another and are fixedly connected to the at least two guide rods in such a way that the first stator and the second stator are spaced apart from one another in the longitudinal direction of the at least two guide rods, wherein the at least one mounting block has a first mounting block and a second mounting block which is different from the first mounting block, and wherein the first stator is fixedly connected to the at least two guide rods by means of the first mounting block and the second stator is fixedly connected to the at least two guide rods by means of the second mounting block.

9. The device according to claim 2, wherein the first slider of the first linear motor is movable out of an arrangement in which it is retracted into the first stator into an arrangement in which it has moved out of the first stator and back into the retracted arrangement again, and wherein the second slider of the second linear motor is movable out of an arrangement in which it is retracted into the second stator into an arrangement in which it has moved out of the second stator and back into the retracted arrangement again, in such a way that during the movement of the first and second sliders out of the first stator and out of the second stator, respectively, the first gripper carriage and the second gripper carriage are moved away from one another.

10. The device according to claim 1, wherein the first gripper carriage or the second gripper carriage, or both, comprise a recess which extends in the longitudinal direction of the at least two guide rods, and wherein the recess is arranged on the first gripper carriage or on the second gripper carriage on a respective side that faces towards the first stator of the first linear motor,
wherein in the case where the first gripper carriage or the second gripper carriage overlaps the first stator in the longitudinal direction of the at least two guide rods, the recess partly surrounds the first stator in order to prevent the first gripper carriage or the second gripper carriage from making contact with the first stator.

11. The device according to claim 2, wherein the first gripper carriage or the second gripper carriage, or both, comprise a further recess which extends in the longitudinal direction of the at least two guide rods, and wherein the further recess is arranged on the first gripper carriage or on the second gripper carriage on a respective further side that faces towards the second stator of the second linear motor,
wherein in the case where the first gripper carriage or the second gripper carriage overlaps the second stator in the longitudinal direction of the at least two guide rods, the further recess partly surrounds the second stator in order to prevent the first gripper carriage or the second gripper carriage from making contact with the second stator.

12. The device according to claim 2, wherein the first stator, or the second stator, or both, are each positionable at various positions in the longitudinal direction of the at least two guide rods and wherein the respective stator is fixedly connected to at least one of the at least two guide rods at one of the various positions.

13. The device according to claim 5, wherein the first gripper arm or the second gripper arm, or both, are of two-part construction, wherein a first part of the two-part gripper arm comprises the force sensor, and wherein a second part of the two-part gripper arm has an arm extension which is detachably connected to the first part.

14. The device according to claim 1, further comprising
a third gripper carriage having a third gripper arm attached thereto,
a fourth gripper carriage having a fourth gripper arm attached thereto.
wherein the third and fourth gripper carriages comprise a non-corrosive material, and the third and fourth gripper arms comprise a non-corrosive material, wherein the third and fourth gripper carriages are each arranged on the at least two guide rods, and wherein at least the third gripper carriage is movable along the at least two guide rods, and wherein the first gripper carriage and the second gripper carriage as well as the third gripper carriage and the fourth gripper carriage are arranged in associated pairs on the at least two guide rods, and
a third linear motor, comprising
a third stator, which is fluid-tightly enclosed by a casing comprising a non-corrosive material, and
a third slider arranged so as to be movable relative to the third stator, which third slider has a fluid-tight slider tube comprising a non-corrosive material, in which permanent magnets are arranged,
wherein the third slider is fixedly connected to the third gripper carriage and the third stator is fixedly connected to at least one of the at least two guide rods, for movement of the third gripper carriage along the at least two guide rods by movement of the third slider relative to the third stator.

15. The device according to claim 14, wherein the fourth gripper carriage is also movable along the at least two guide rods, and wherein the device further comprises a fourth linear motor, the fourth linear motor comprising
a fourth stator, which is fluid-tightly enclosed by a casing comprising a non-corrosive material, and
a fourth slider arranged so as to be movable relative to the fourth stator, which fourth slider has a fluid-tight slider tube comprising a non-corrosive material, in which permanent magnets are arranged,
wherein the fourth slider is fixedly connected to the fourth gripper carriage and the fourth stator is fixedly connected to at least one of the at least two guide rods, for movement of the fourth gripper carriage along the at least two guide rods by movement of the fourth slider relative to the fourth stator.
